(19) United States
(12) Patent Application Publication
(10) Pub. No.: US 2004/0128479 A1
(43) Pub. Date: Jul. 1, 2004

(54) Method and apparatus for variable length instruction parallel decoding

(76) Inventors: Venkateswara Rao Madduri, Austin, TX (US); Ross A. Segelken, Portland, OR (US); Bret Leslie Toll, Hillsboro, OR (US)

Correspondence Address: KENYON & KENYON, 1500 K STREET, N.W., SUITE 700, WASHINGTON, DC, 20005, US

(21) Appl. No.: 10/331,335

(22) Filed: Dec. 31, 2002

(51) Int. Cl. G06F 9/30

(52) U.S. Cl. 712/210

(57) ABSTRACT

A method and an apparatus for decoding a variable length instruction. The method includes selecting with a first pointer one of a plurality of permutations, each permutation representing a possible location of the instruction in a portion of the datastream, calculating a possible length of the instruction for each byte in the selected permutation, and selecting the length of the instruction from one of the calculated possible lengths in the selected permutation. An example of an application includes decoding X86 instruction formats.

### BACKGROUND OF THE INVENTION

1. Field of the Invention

Embodiments of the present invention relate generally to decoding. More specifically, the embodiments provide a method and an apparatus for parallel decoding of variable length instructions.

2. Description of the Related Art

Decoding a variable length instruction is typically a serial process. The first four bytes of an instruction are used to determine the length of the instruction. Only after decoding serially each of the bytes from the start of the instruction can it be determined whether the next byte is needed to completely decode the instruction. Additionally, a prefix of the instruction, if any, must be decoded. In some instances, the prefix changes the length of the instruction. Thus, in decoding the instruction, there is no way to know in advance where the instruction begins and ends in a datastream. Until the instruction is completely decoded, its prefix-changed length is not known. As such, this decoding process takes a great deal of time and slows down the processor, such that decoding a variable length instruction is typically the bottleneck in a processor.

One decoder has been implemented to decode variable length instructions in a parallel process. This decoder implements a parallel process including two pipestages. In a first pipestage, the decoder makes assumptions about the variable instruction length based on the presence or absence of instruction prefixes. In a second pipestage, the decoder then validates the appropriate assumption and selects the correct instruction length, marking the beginning and ending of the instruction. In order to perform this parallel process, the decoder performs the same calculation on different instruction bytes in parallel. This requires redundant circuitry and power requirements for each data byte processed in parallel and for combining the outputs of the redundant circuitry.

Since there is a decoding dependency between the instruction bytes and since some prefixes change the instruction length, it is difficult to reduce the output-combining circuitry and the redundant decoding circuitry and power requirements for the parallel process without sacrificing processing speed.

### BRIEF DESCRIPTION OF THE DRAWINGS

FIG. 1 is an X86 instruction format to which an embodiment of the present invention may be applied;

FIG. 2 is an illustration of the parallel decoding method of an embodiment of the present invention;

FIG. 3 is a block diagram of a variable length parallel decoder of an embodiment of the present invention;

FIG. 4 is a block diagram of a decode sub-unit in the decoder of an embodiment of the present invention;

FIG. 5 is a block diagram of a length sub-unit in the decoder of an embodiment of the present invention;

FIG. 6 is a block diagram of a length control select unit and a valid begin unit of a control generator in the decoder of an embodiment of the present invention;

FIG. 7 is an example of a decoding structure used in accordance with the method of an embodiment of the present invention;

FIG. 8 is a block diagram of a section of a marker unit in the decoder of an embodiment of the present invention;

FIG. 9 is a block diagram of another section of the marker unit of FIG. 8 and an overflow pointer unit in the decoder of an embodiment of the present invention;

FIG. 10 is a block diagram of a section of another marker unit in the decoder of an embodiment of the present invention;

FIG. 11 is a block diagram of another section of the marker unit of FIG. 10 in the decoder of an embodiment of the present invention;

FIG. 12 is a block diagram of a wrap pointer unit in the decoder of an embodiment of the present invention;

FIG. 13 is a block diagram of another section of the marker unit of FIG. 8 in the decoder of an embodiment of the present invention;

FIG. 14 is a block diagram of another section of the marker unit of FIG. 10 in the decoder of an embodiment of the present invention;

FIGS. 15A-15C are flowcharts of three respective pipestages illustrating how a variable length instruction is decoded in parallel in accordance with the method of an embodiment of the present invention;

FIG. 16 is an example of a computer system for implementing the method of an embodiment of the present invention; and

FIG. 17 shows examples of begin and end instruction marks generated by the decoder according to an embodiment of the present invention.

### DETAILED DESCRIPTION

Embodiments of the present invention include a method and an apparatus for decoding variable length instructions using parallel processes. These embodiments may advantageously reduce redundancy in circuitry and power requirements and output-combining circuitry for parallel decoding processes. As such, embodiments of the present invention may increase processor speed, reduce power consumption, and minimize processor area over existing decoding processes, thereby removing the decoding process from the critical path of processor design. In one embodiment of a method of the present invention, the method may include selecting with a first pointer one of a plurality of permutations, each permutation representing a possible location of the instruction in a portion of the datastream, calculating a possible; length of the instruction for each byte in the selected permutation, and selecting the length of the instruction from one of the calculated possible lengths in the selected permutation. The method may also include three pipestages to perform the parallel decoding of the instruction.

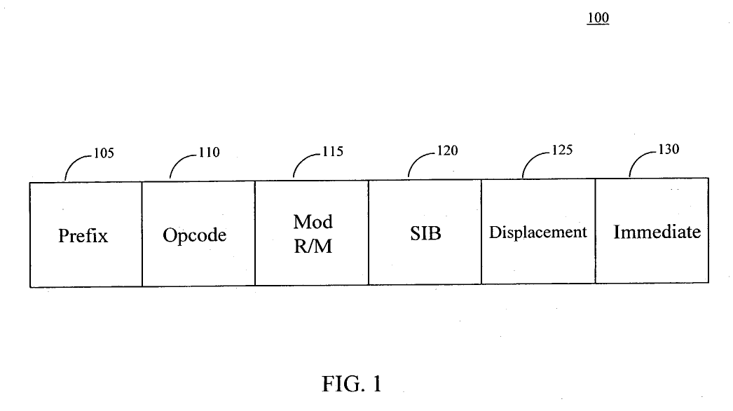

FIG. 1 illustrates an X86 instruction format 100 to which embodiments of the present invention may be applied. The format includes a prefix 105, an opcode 110, a modulo-register/memory (ModR/M) byte 115, a scale index base (SIB) byte 120, displacement bytes 125, and immediate bytes 130. The instruction may be 1 to 15 bytes long, including 0 to 14 prefix bytes, 1 or 2 opcode bytes, 0 or 1 ModR/M byte, 0 or 1 SIB byte, 0 to 6 displacement bytes, and 0 to 4 immediate bytes.

It may be understood that the X86 instruction format is an example only as embodiments of the present invention may be applied to any format a processor uses.

Prefix 105 may, optionally, appear before opcode 110 in order to override certain default-attributes of the opcode. Several prefixes may be used. In the embodiments of the present invention, the prefixes of interest vary the instruction length from instruction to instruction. Such prefixes may include an operand size override prefix (66H), an address size override prefix (67H), and a combined operand and address size override prefix (6667H).

The operand size override prefix toggles the default size of the operand specified by the instruction. For example, a 16-bit instruction having this prefix specifies a 32-bit operand instead of the default 16-bit operand. So, the instruction length is increased by 2 bytes. Conversely, a 32-bit instruction specifies a 16-bit operand instead of the default 32-bit operand, such that the instruction length is decreased by 2 bytes.

The address size override prefix toggles the default size of the address specified by the instruction. For example, a 16-bit instruction having this prefix specifies a 32-bit address specifier instead of the default 16-bit address specifier, increasing the instruction length by 2 bytes. Conversely, a 32-bit instruction specifies a 16-bit address specifier instead of the default 32-bit address specifier, decreasing the instruction length by 2 bytes.

The combined operand and address size override prefix toggles the default sizes of both the operand and address specified by the instruction. The combined prefix effectively toggles the processor default bit (D-bit) on a per instruction basis. The D-bit is initialized at the beginning of processor operation to define the processor's mode of operation as either 16-bit or 32-bit mode. In 16-bit mode, both the operands and the addresses are 16 bits long. In 32-bit mode, both the operands and the addresses are 32 bits long. Hence, the combined prefix increases or decreases the instruction length by as many as 4 bytes.

Opcode 110 identifies the operation to be performed by the instruction. From the variable length decoding viewpoint, the opcode specifies the numbers of displacement and immediate bytes and the presence of the ModR/M byte. One opcode can specify 0 to 6 displacement bytes and 0 to 4 immediate bytes. Most opcodes are 1 byte long; however, some are 2 bytes long.

ModR/M byte 115 indicates the source or destination memory type, i.e., an address register or memory address, to be accessed by the instruction. One embodiment of the instruction includes a ModR/M byte only when opcode 110 does not itself specify the number of displacement bytes. ModR/M byte 115 does so instead. ModR/M byte 115 can specify 0 to 4 displacement bytes or a second ModR/M byte called a scale index-base (SIB) byte.

Scale index base byte (SIB) 120 specifies a more complex addressing mode than the default 32-bit mode. One embodiment of the instruction includes a SIB byte only when operating in 32-bit mode and when specified by ModR/M byte 115. SIB byte 120, rather than ModR/M byte 115, specifies the number of displacement bytes. SIB byte 120 may specify 0 to 4 displacement bytes.

Displacement bytes 125 indicate the offset from the base address in memory that the instruction accesses. For example, the instruction provides for opcode 110 operating on data in a particular memory location, which is determined by retrieving a base address from a register, multiplying the retrieved address by the index in SIB byte 120, and adding the multiplied result to the offset stored in displacement bytes 125.

Immediate bytes 130 include constants that the instruction uses, rather than accessing data from memory.

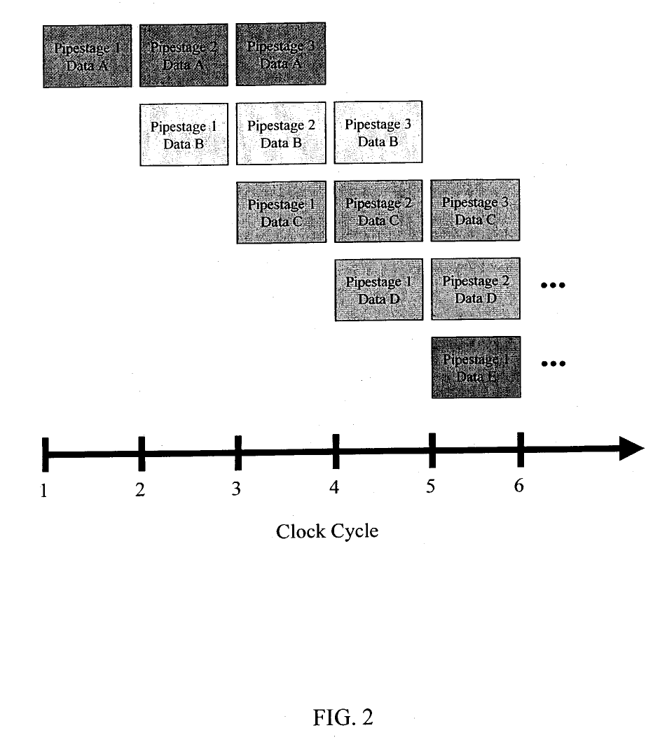

FIG. 2 illustrates a method for parallel decoding of variable length instructions, such as the X86 instruction, according to embodiments of the present invention. In an embodiment of the present invention, a datastream including at least one instruction may load into an instruction buffer of a processor. The processor may then decode the datastream in parallel processes, called pipestages, and identify the instruction by locating its begin and end bytes in the datastream. The processor may then execute the instruction. In the example of FIG. 2, the datastream includes one or more variable length instructions. The datastream may be divided into data chunks, designated Data A, Data B, etc., where each chunk size is 8 bytes. Three pipestages may be used to decode in parallel and determine where the variable length instructions begin and end. Each pipestage performs a different part of the decoding, where Pipestage 1 performs the first part of the decoding, Pipestage 2 performs the second part of the decoding, and Pipestage 3 performs the last part of the decoding. Each pipestage's decoding will be described later.

During the processor's first clock cycle, the first data chunk, Data A, is processed in Pipestage 1. During the second clock cycle, the first data chunk passes to Pipestage 2 and is processed there. Concurrently, the second data chunk, Data B, is processed in Pipestage 1. In the next clock cycle, the first data chunk passes to Pipestage 3 and is processed there. The second data chunk passes to Pipestage 2 and is processed there. And the third data chunk, Data C, is processed in Pipestage 1. In the fourth clock cycle, the first data chunk has completed. The second data chunk is processed in Pipestage 3, the third data chunk is processed in Pipestage 2, and the fourth data chunk is processed in Pipestage 1, concurrently. This operation continues until all the data chunks are processed. In this operation, three data chunks are processed concurrently during each clock cycle in a different pipestage. Thus, the speed of the decoding process is improved.

Additionally, decoded information from Data A is passed to Data B to be used in its decoding so that less decoding may be done to Data B. As such, less decoding logic is used, thereby reducing power consumption, number of hardware components, and processor area.

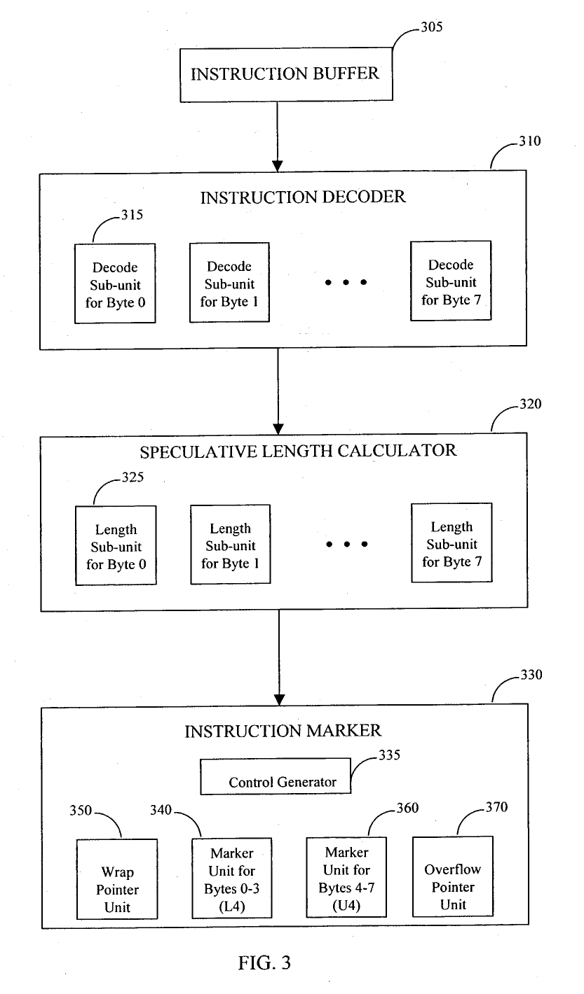

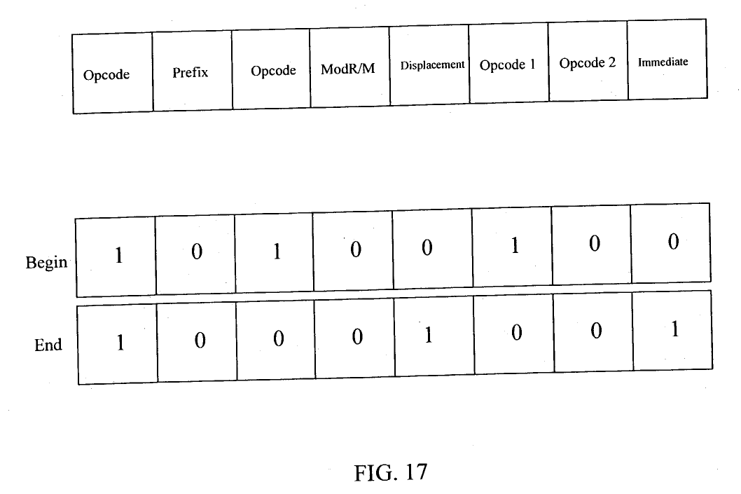

FIG. 3 is a block diagram of an embodiment of a variable length parallel decoder that may perform the parallel decoding method. The decoder may include an instruction buffer 305, an instruction decoder 310, a speculative length calculator 320, and an instruction marker 330. The instruction buffer 305 may sequentially store 8-byte chunks of the datastream to await decoding. Instruction decoder 310 may decode each of the 8 bytes of the chunk in a decode sub-unit 315 in order to identify prefixes, opcodes, and ModR/M bytes. Speculative length calculator 320 may calculate the possible (or speculative) instruction lengths for each of the 8 bytes in a length sub-unit 325, presuming that that byte is the beginning of the instruction. Instruction marker 330 may divide the 8-byte chunk into two 4-byte chunks, a lower 4-byte chunk (L4) and an upper 4-byte chunk (U4), for faster processing. Marker 330 may also mark an instruction's begin and end bytes, if any, in the 8-byte chunk, using a control generator 335, marker units 340, 360, a wrap pointer unit 350, and an overflow pointer unit 370 so that the lengths of variable length instructions become readily apparent. The variable instruction lengths may be indicated by begin and end marks as illustrated in FIG. 17, for example. The components of the variable length decoder will be described in detail later.

By first dividing the datastream into 8-byte chunks and then dividing each 8-byte chunk into two 4-byte chunks, the dependency of each byte in the datastream may be reduced. This dependency refers to the correlation between adjacent bytes in the datastream during decoding. In conventional decoders, the correlation may be high because of the serial decoding process, where the next byte to be decoded is determined after the current byte is decoded, etc., such that all the bytes in the instruction are decoded serially. In contrast, in the embodiments of the present invention, the maximum dependency may be 3 bytes in each 4-byte chunk. For example, the fourth byte in each 4-byte chunk may be dependent on at most the instruction lengths of the first three bytes. By reducing the dependency, the serial ripple may be reduced to 3, thereby easing circuit requirements and speeding up the decoding process.

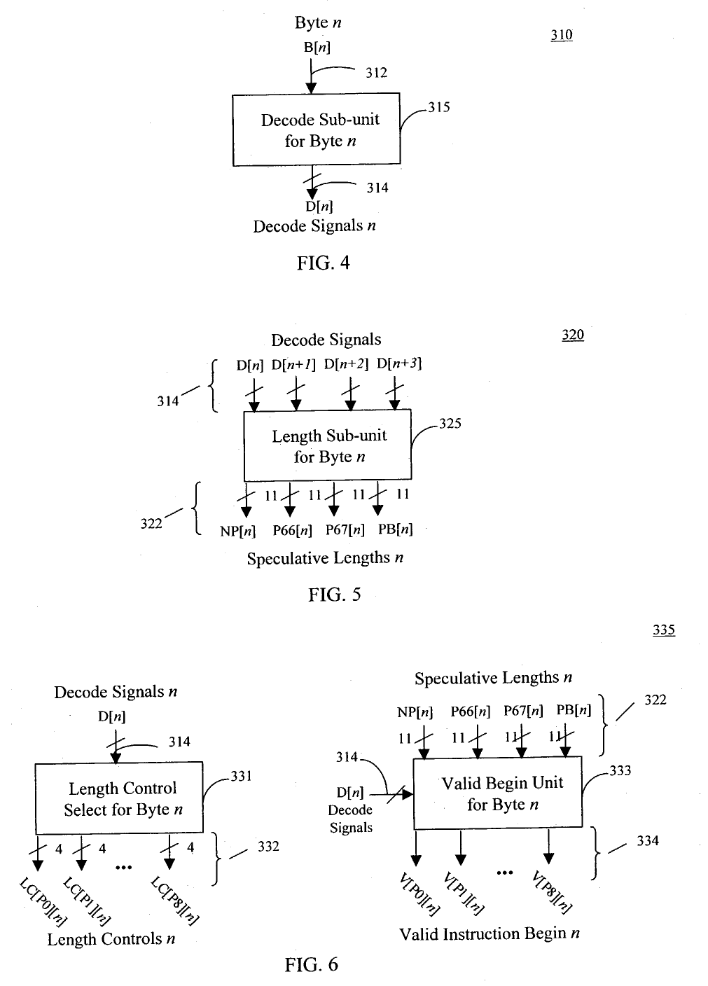

FIG. 4 is a block diagram of decode sub-unit 315 in instruction decoder 310. Decoder 310 may include a decode sub-unit 315 for each byte. In this embodiment, the chunk has 8 bytes; therefore, decoder 310 may include 8 decode sub-units 315. So, the 8 bytes may be decoded in parallel. For an nth byte 312, B[n], of the 8-byte chunk, where n=0, . . . , 7, byte 312 may enter decode sub-unit 315, where byte 312 may be decoded to determine if byte 312 is a prefix, a first opcode byte, a second opcode byte, or a ModR/M byte. Recall that the length of an instruction may be determined from the first four bytes of the instruction. Thus, the determination of whether the current byte is any of these four types may begin the determination of an instruction's length. Decode sub-unit 315 may generate a set of 1-bit decode signals 314, D[n], indicating the possible byte types, e.g. an address size override prefix, an operand size override prefix, a combined address and operand size override prefix, a 1-byte opcode, a first byte of a 2-byte opcode, a second byte of a 2-byte opcode, a ModR/M byte, a 1-byte opcode which is followed by an immediate byte, etc. In some instances, 5 bits of the next byte 312 may be used to facilitate this byte type determination. In an example, a number of possible byte types is 35. A decode signal may be asserted (as a ‘1’) if the decoded byte matches that byte type; otherwise, the signal may be ‘0’. For example, if decode sub-unit 315 decodes Byte 0 and determines that Byte 0 is a 1-byte opcode, then the decode signal corresponding to a 1-byte opcode is ‘1’ and the remaining decode signals are ‘0’. Each decode sub-unit 315 may output decode signals 314 of byte 312 that sub-unit 315 has decoded.

FIG. 5 is a block diagram of length sub-unit 325 in speculative length calculator 320. Calculator 320 may include a length sub-unit 325 for each byte 312. So, calculator 320 may include 8 length sub-units 325. And the 8 bytes may be processed in parallel. A byte's decode signals 314 from instruction decoder 310 may enter corresponding length sub-unit 325. Since the length of an instruction may be determined from the instruction's first four bytes, decode signals 314 for the next 3 bytes (n+1, n+2, n+3) may also be inputted to length sub-unit 325. Now, 11 speculative instruction lengths may be calculated based on the asserted decode signals 314, presuming the byte in question n is the beginning of the instruction. The result may be an 11-bit signal, each bit corresponding to a possible length from 1 to 11 bytes of the instruction. A single bit of the 11-bit speculative length signal may be asserted (as a ‘1’) if the corresponding speculative length is possible. The 11-bit speculative length signal may be calculated for each of the following length types: an instruction with no prefix (NP), an instruction with an operand size override prefix (P66), an instruction with an address size override prefix (P67), and an instruction with both an operand and an address size override prefix (PB). For example, if decode signal 314 asserts that the byte in question is a 1-byte opcode, then the instruction length, beginning with this 1 byte opcode, may possibly be 1 byte long. So, the first bit of the 11-bit speculative signal may be asserted (as a ‘1’ ) for an instruction with no prefix. A different bit may be asserted for the P66, P67, or PB instruction types because the instruction length may be changed by the prefix. Each length sub-unit 325 may output the four 11-bit speculative length signals 322 for its byte 312.

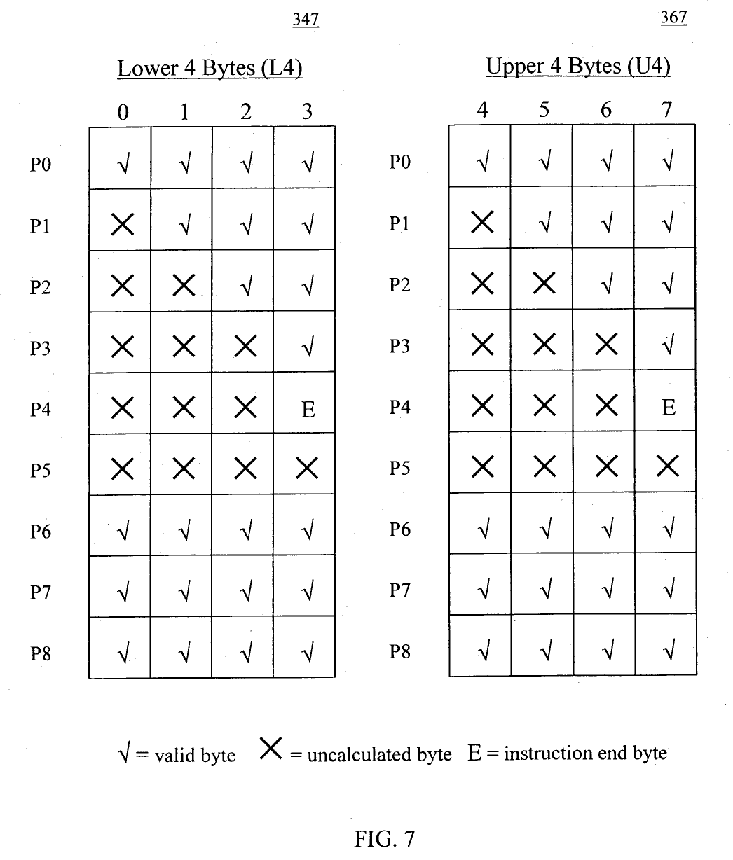

FIG. 6 is a block diagram of the components of control generator 335 in instruction marker 330. Control generator 335 may provide control inputs to the data structure shown in FIG. 7 of marking units 340, 360 in order to determine instruction begin and end marks. Control generator 335 may include a length control select 331 and a valid begin unit 333. Length control select 331 may indicate to which of the four speculative length types 322 the byte being processed belongs. Decode signals 314 of the byte in question 312 may be inputted to length control select 331. For each permutation (i.e. each row) in FIG. 7 of that byte, length control select 331 may output a 4-bit control signal 332 corresponding to the four speculative length types, NP, P66, P67, and PB. For example, as shown in FIG. 6, LC[P0][n] is a 4-bit control signal 332 for byte n in Permutation 0. Only 1 bit in each of the 4-bit signals 332 may be asserted (as a ‘1’ ) to indicate whether that byte 312 in that permutation is speculatively of type NP, P66, P67, or PB. For this embodiment, there may be 9 permutations for each of the L4 and U4 bytes. So, each length control select 331 may output nine 4-bit control signals 332, called length controls. Each length control select 331 may output length controls 332 to the appropriate element of the data structure in FIG. 7. The data structure will be described in detail later.

FIG. 7 shows the data structure for each of the L4 and U4 bytes. The lower chunk (L4) structure 347 includes Bytes 0-3 and the upper chunk (U4) structure 367 includes Bytes 4-7 of the 8-byte chunk. Each data structure may include 9 permutations (P0-P8) with 4 elements in each row. Each element may represent a byte position. The symbol √ indicates the bytes, called valid bytes, for which instruction marker 330 may generate the begin and end instruction marks. The symbol × indicates the bytes for which the begin and end marks may not be generated. The symbol “E” indicates the end of an instruction. Control generator 335 may be associated with each of the valid bytes.

The first 4 permutations of each structure 347, 367, may represent the possibility that each byte is the start of the instruction. So, looking at L4 structure 347, in permutation 0 (P0), byte 0 may be assumed to be the start byte of the instruction. Thus, all 4 bytes begin and end marks may be calculated. In permutation 1 (P1), byte 1 may be assumed to be the start byte of the instruction. As such, byte 0 may not be relevant and, therefore, its marks not calculated. Only bytes' 1-3 marks may be calculated. In permutation 2 (P2), byte 2 may be assumed to be the start byte of the instruction. So, bytes 0-1 may not be relevant and, therefore, their marks not calculated. Only bytes 2-3 marks may be calculated. Similarly, in permutation 3 (P3), byte 3 may be assumed to be the start of the instruction and the only byte for which marks may be calculated.

Five additional possibilities may be represented in the permutations. In permutation 4 (P4), byte 3 may be assumed to be the end of the instruction. In permutation 5 (P5), neither start nor end of the instruction may be assumed to be present in the 4 bytes. Hence, none of the bytes' marks may be calculated. This permutation may be used for instances where the chunk is in the middle of the instruction. Permutations 6-8 may assume that a prefix of the instruction has been identified in a previous chunk. As such, the marks for all the bytes may be calculated. In permutation 6 (P6), a prefix 66H may have been identified in a previous chunk indicating that the operand size and, hence, the instruction length may change. Similarly, in permutation 7 (P7), a prefix 67H may have been identified in a previous chunk indicating that the address size and the instruction length may change. In permutation 8 (P8), a prefix 6667H may have been identified in a previous chunk indicating that both the operand and address sizes may change along with the instruction length. Of the 9 permutations, the one that correctly represents the instruction currently being processed may be selected, as will be described later. Therefore, these permutations may be advantageously used to quickly determine the instruction length based on the speculative start of the instruction and the end of the previous instruction.

Referring again to FIG. 6, valid begin unit 333 may indicate whether a valid byte position could potentially be the beginning of an instruction. The four 11-bit speculative length signals 322 and the decode signals 314 of the byte in question may be inputted to valid begin unit 333. For each permutation in FIG. 7 of that byte, valid begin unit 333 may output 1 bit 334, based on speculative length signals 322 and decode signals 314, indicating whether that byte could be a beginning of an instruction. For example, as shown in FIG. 6, V[P0][n] is a 1-bit signal 334 indicating whether byte n in Permutation 0 could be the beginning of the instruction. The bit 334 may be asserted (as a ‘1’) if the byte in that permutation could possibly be a first byte in the instruction. Each valid begin unit 333 may output the nine 1-bit signals 334 to an appropriate element of the data structure of FIG. 7.

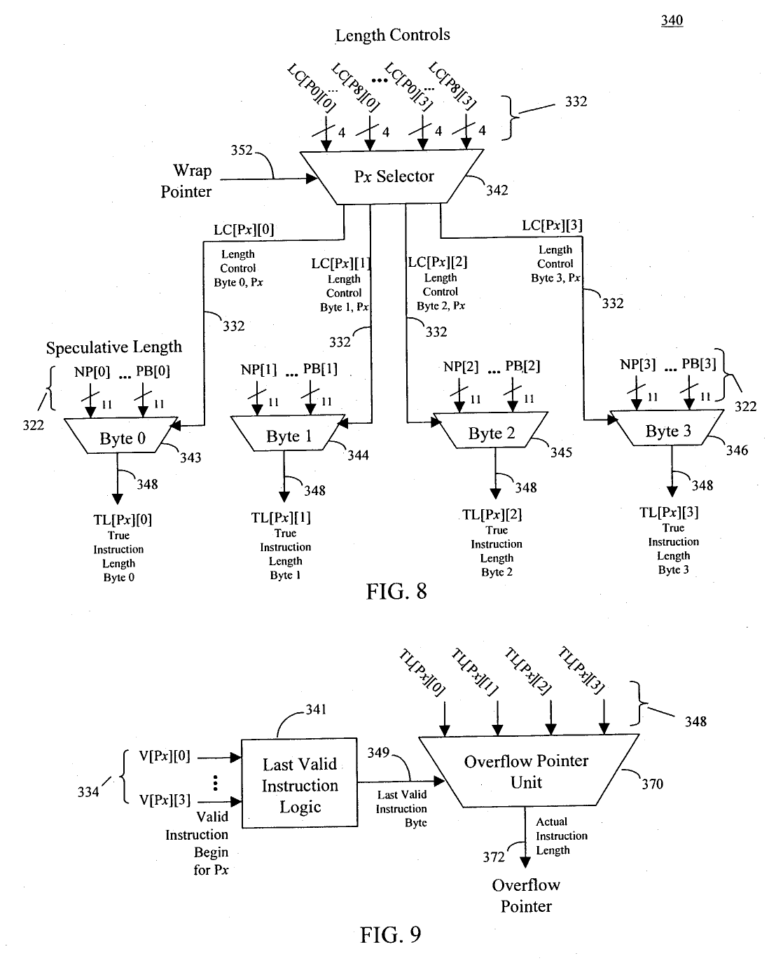

FIG. 8 is a block diagram of a section of marker unit 340 for the lower 4-byte chunk (L4). This section of marker unit 340 may include a permutation (Px) selector 342 and true length selectors 343-346 for bytes 0-3. Control generator 335 may input length controls 332 for each byte 0-3 in each permutation P0-P8 to Px selector 342. As a result, 36 4-bit length controls 332 may be inputted to selector 342. A wrap pointer 352 may also be inputted to selector 342. Based on wrap pointer 352, selector 342 may select the permutation that represents the correct position of the instruction. The representative permutation is the permutation that correctly indicates the beginning byte position of the instruction in the L4 chunk. Wrap pointer 352 will be discussed in detail later.

By applying wrap pointer 352 to selector 342, embodiments of the present invention advantageously reduce the amount of circuitry, power consumption, and time used to decode an instruction. This may be done by selecting one of the permutation and processing the selected permutation to calculate the instruction length, rather than calculating instruction lengths for all the permutations and then selecting the correct permutation. Therefore, embodiments of the present invention may reduce the circuitry and power redundancy by 8 times. Additionally, embodiments may reduce processing time by performing fewer calculations, including some output-combining calculations.

Referring to FIG. 8, Px selector 342 may then output length controls 332 for each byte 0-3 for only the selected permutation, Px. For example, as shown in FIG. 8, LC[Px][0] is outputted from selector 342, indicating length control 332 for byte 0 in selected Permutation x. Each selected length control 332 may be inputted to respective true length selectors 343-346. Additionally, speculative length signals 322 may be inputted to respective true length selectors 343-346. For example, speculative length signals 322 for byte 0 and length control 332 for byte 0 may be inputted to true length selector 343 for byte 0. Similarly, speculative length signals 322 for byte 1 and length control 332 for byte 1 may be inputted to true length selector 344 for byte 1. Similar configurations may be shown for bytes 2 and 3. As stated previously, length control 332 may indicate whether the byte in question is part of an instruction of type NP, P66, P67, or PB. And, speculative length signals 322 may indicate possible lengths of the instruction beginning with the byte in question for the four instruction types, i.e., NP, P66, P67, or PB. So, true length selectors 343-346 may select using length controls 332 the speculative length signals 322 that indicates the length for the instruction assuming the byte in question is the beginning of the instruction. For example, length control 332 for byte 0 may indicate that byte 0 is part of an instruction with no prefix, i.e., NP. Then, true length selector 343 for byte 0 may select speculative length signal NP[0]. Speculative length signal NP[0] may indicate an instruction length of 5 bytes, assuming byte 0 is the beginning of the instruction. So, true length selector 343 may output a “true” length 348, TL[Px][0], indicating that the correct instruction length would be 5 bytes, assuming byte 0 is the beginning of the instruction. True length selectors 344-346 may perform similarly.

FIG. 9 is a block diagram of another section of marker unit 340 and an overflow pointer unit 370 for the lower 4-byte chunk (L4). This section of marker unit 340 may include a last valid instruction logic 341. Last valid instruction logic 341 may determine which of the four bytes 0-3 in the selected Permutation x is the actual beginning byte of the instruction. Valid instruction begin signals 334 for each byte 0-3 in the selected Permutation x may be received from valid begin unit 333 into last valid instruction logic 341. For example, as shown in FIG. 9, begin signals 334, V[Px][0] may be inputted to logic 341, indicating a begin signal 334 for byte 0 in Permutation x. As stated previously, valid instruction begin signals 334 may indicate whether a valid byte position may potentially be a beginning of the instruction. Only one of these begin signals 334 may be asserted in a permutation. Thus, the asserted signal 334 may indicate which byte is the beginning of the instruction. Logic 341 may then output the last valid instruction byte signal 349, indicating the instruction beginning byte number. For example, if V[Px][1] is asserted, then last valid instruction byte signal 349 indicates byte 1 as the instruction beginning.

Overflow pointer unit 370 may determine which permutation in the upper 4-byte chunk (U4) represents the position of the current instruction or the begin position of the next instruction in the U4 chunk. For example, L4 may include a 1-byte instruction at bytes 0 and 1 and a 3-byte instruction at byte 2. As such, the last valid instruction in L4 begins at byte 2. The instruction's length is 3-bytes—L4 bytes 2 and 3 and U4 byte 4. There is an overflow of the instruction from L4 to U4. So, an overflow pointer 372 indicates the appropriate permutation in U4 in which byte 4 belongs to the current instruction. It follows then that the next instruction starts at byte 5. As shown in FIG. 7, the representative permutation is P1 in U4. So, overflow pointer 372 may point to U4 permutation 1. The dependencies between the L4 and U4 chunks have now been resolved.

Referring to FIG. 9, “true” instruction lengths 348 of the bytes 0-3 and last valid instruction byte 349 may be inputted to overflow pointer unit 370. Overflow pointer unit 370 may then select the actual length of the last valid instruction in L4. Based on this length, overflow pointer 372 may be generated and output from overflow pointer unit 370.

It may be understood that, initially, overflow pointer 372 may be null, indicative of the beginning of the datastream where there are no previous instructions. After the first L4 bytes are processed, overflow pointer 372 may be first generated and used with the first U4 bytes and so on.

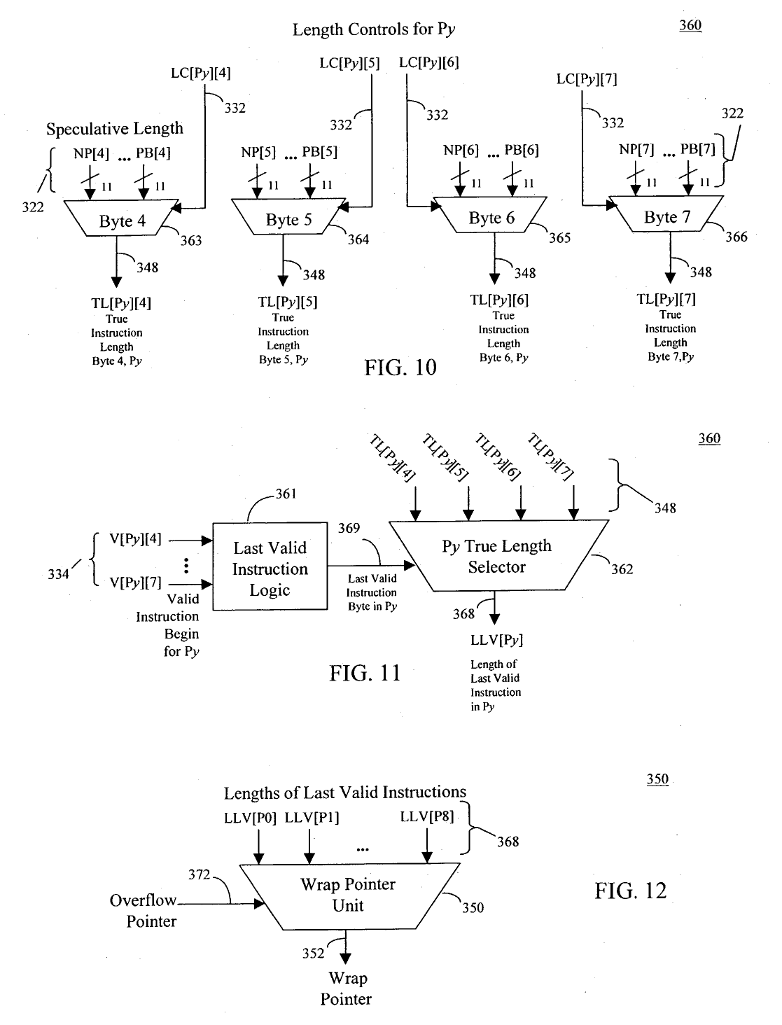

FIG. 10 is a block diagram of a section of marker unit 360 for the upper 4-byte chunk (U4). This section may include true length selectors 363-366. There may be a true length selector for each byte in each permutation. For example, in an embodiment of the present invention with 4 bytes in the upper chunk and 9 permutations, there may be 36 true length selectors. Control generator 335 may input length controls 332 for each byte 4-7 in each permutation P0-P8 to the corresponding true length selector. For example, true length selector 363 may receive length control 332, LC[P0][4], indicating length control 332 for byte 4 of Permutation 0. Speculative length signals 322 may be inputted to respective true length selectors 363-366. For example, the four 11-bit speculative length signals 322, NP[4], P66[4], P67[4], and PB[4], may be inputted to true selector 363, the true selector for byte 4. Similarly, speculative length signals 322 for bytes 5-7 may be inputted to corresponding true length selectors 364-366. Thus, true length selectors 363-366 may receive the appropriate speculative length signals 322 and corresponding length control signals 332. True length selectors 363-366 may select using length controls 332 the speculative length signal 322 that indicates the possible length for the instruction assuming the byte in question in the permutation in question is the beginning of the instruction. True length selectors 363-366 may then output a “true” length 348 for each byte in each permutation of U4.

This U4 configuration is different from the L4 configuration in which wrap pointer 352 selects one permutation and thereby reduces the true length selectors 343-346 to four rather than thirty-six. This U4 configuration may be performed in parallel with the L4 configuration. As such, L4 chunk processing may not have yet generated overflow pointer 372 prior to U4 chunk processing. As such, the appropriate U4 permutation may not yet be selected with overflow pointer 372. On the other hand, wrap pointer 352 may have already been generated from the previous U4 chunk processing, so the L4 configuration may immediately use wrap pointer 352 in the present computation in order to select the L4 permutation prior to any further computations. The L4 configuration may significantly reduce the power consumption and circuitry redundancy. In addition, the L4 configuration may eliminate some output-combining circuitry, e.g., Py true length selector 362, used in the U4 configuration. And the U4 configuration may be performed in parallel with the L4 configuration to generate wrap pointer 352 for the next L4 chunk.

FIG. 11 is a block diagram of another section of marker unit 360 for the upper 4-byte chunk (U4). This section of marker unit 360 may include a last valid instruction logic 361 and a permutation (Py) true length selector 362. There may be logic 361 and selector 362 for each permutation. So, in an embodiment of the present invention in which there are 9 permutations, there may be 9 logics 361 and 9 selectors 362 for U4.

Last valid instruction logic 361 may determine which of the four bytes 4-7 in each permutation P0-P8 may be the beginning byte of the instruction. Valid instruction begin signals 334 for each byte 4-7 in a permutation may be received from valid begin unit 333 into last valid instruction logic 361. For example, V[P01[4] through V[P0][7] may be inputted to logic 361, indicating begin signal 334 for bytes 4-7 in Permutation 0. Only one of these begin signals 334 may be asserted in a permutation. The asserted signal 334 may indicate which byte in that permutation may be the beginning of the instruction, assuming that that permutation is the correct one. Logic 361 may then output the last valid instruction byte signal 369, indicating the instruction beginning byte number. For example, if V[P0][6] is asserted, then last valid instruction byte signal 369 indicates byte 6 in Permutation 0 as the instruction beginning in Permutation 0. Similar logic 361 for each permutation may output last valid instruction byte signal 369 for that permutation.

Permutation true length selector 362 may select the true instruction length 348 for each permutation. True instruction lengths 348 of the bytes 4-7 and last valid instruction byte 369 for the permutation may be inputted to selector 362. True instruction lengths 348 may be received from true length selectors 363-366. Selector 362 may then output the length of the last valid instruction 368 for that permutation beginning with the last valid instruction byte 369. Similar selectors 362 for each permutation may output length 368 for that permutation.

FIG. 12 is a block diagram of wrap pointer unit 350 in instruction marker 330. Wrap pointer unit 350 may select a permutation in L4 that represents the valid position of an instruction in the 8-byte chunk. For example, suppose byte 5 of the previous 8-byte chunk is the start of the previous 5-byte instruction. Then, the previous U4 bytes 5, 6, and 7 and the current L4 bytes 0 and 1 make up the previous instruction. Thus, the current instruction starts at L4 byte 2. A wrap pointer 352 may indicate the permutation in L4 in which the current instruction starts at byte 2 and bytes 0-1 belong to the previous instruction. As shown in FIG. 7, the representative permutation is permutation 2 (P2) of the L4 chunk. So, wrap pointer 352 may point to L4 permutation 2 (P2). The dependencies between the adjacent 8-byte chunks have now been resolved.

The speculative lengths 368 of the last valid instruction in each of the U4 permutations and overflow pointer 372 may be inputted to wrap pointer unit 350. Wrap pointer unit 350 may then select the representative L4 permutation and the corresponding actual length of the last valid instruction. Based on this length, wrap pointer 352 may be generated and output from wrap pointer unit 350.

Unlike some serial and parallel decoding processes which fully decode all 9 permutations, an embodiment of the present invention may use wrap pointer 352 to select one of the L4 permutations on which further decoding is performed. Additionally, unlike other speculative decoders, embodiments of the present invention may select which L4 permutation is correct and calculate the actual length from that permutation rather than from all the permutations. As such, only the bytes of the selected permutation may be fully decoded. Therefore, the amount of logic used to further decode the data is significantly reduced. The processing area is smaller and the power consumption due to fewer decoding logic components is lower.

It may be understood that, initially, wrap pointer 352 may be null, indicative of the beginning of the datastream where there are no previous instructions. In this case, wrap pointer 352 may point to the first byte in the datastream. After the first 8 bytes are processed, wrap pointer 352 may be generated and used with the second 8 bytes and so on.

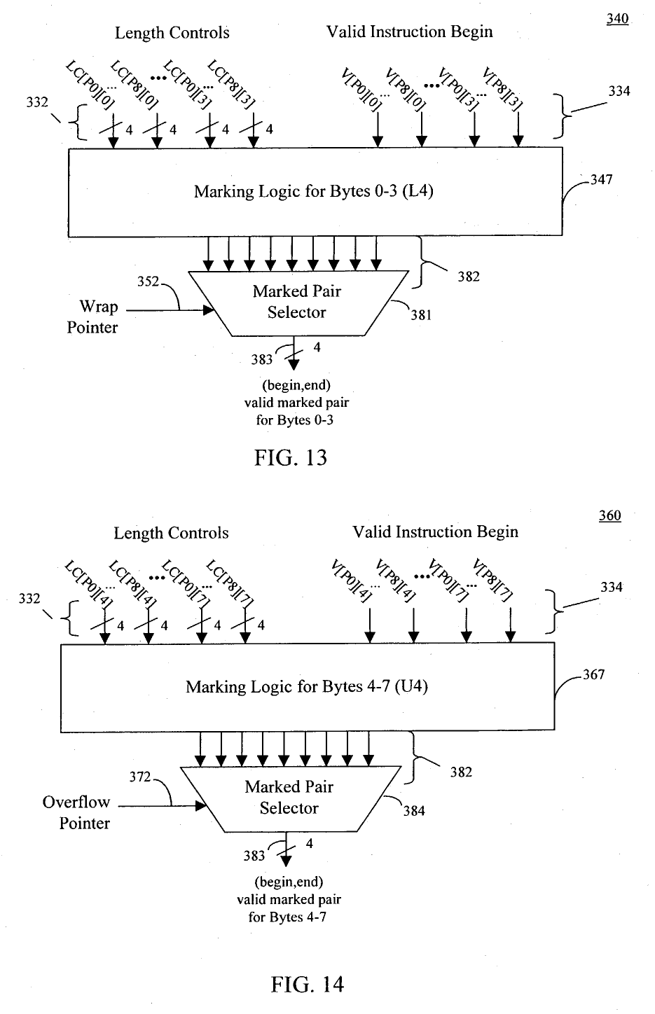

FIG. 13 is a block diagram of another section of marker unit 340 for bytes 0-3. This section of marker unit 340 may generate the begin and end marks for the instruction, indicating where a variable length instruction begins and ends.

Begin and end marks may be generated as a binary pair (begin, end). If a byte is the first byte of an instruction, the begin and end marks for that byte may be indicated by (1,0). Similarly, if a byte is the last byte of an instruction, the begin and end marks for that byte may be indicated by (0,1). If a byte is a 1-byte instruction, the begin and end marks may be (1,1). Conversely, if the byte is neither the beginning nor end of an instruction, the begin and end marks for that byte may be (0,0). FIG. 17 shows examples of begin and end marks.

Referring to FIG. 13, this section of marker unit 340 may include a marking logic 347 and a marked pair selector 381. Marking logic 347 may receive length controls 332 and valid instruction begins 334 from control generator 335. Marking logic 347 may include the L4 data structure of FIG. 7. Marking logic 347 may then use these inputs to determine begin and end marks for each byte 0-3 in each permutation. Marking logic 347 may then output a set of marked pairs 382 for each permutation. In an embodiment of the present invention, 9 sets of marked pairs 382, each set including 4 marked pairs (one pair for each byte), for each permutation may be output to selector 381.

Marked pair selector 381 may then select the set of marked pairs 382 based on wrap pointer 352. Wrap pointer 352 may indicate the correct permutation of the instruction in L4 chuck. And selector 381 may output the correct set of marked pairs 383.

FIG. 14 is a block diagram of another section of marker unit 360 for bytes 4-7. This section may include a marking logic 367 and a marked pair selector 384. This section may perform the same function as the section of marker unit 340 in FIG. 13. Marking logic 367 may include the U4 data structure of FIG. 7. This section may output the correct set of marked pairs 383 for bytes 4-7 using overflow pointer 372.

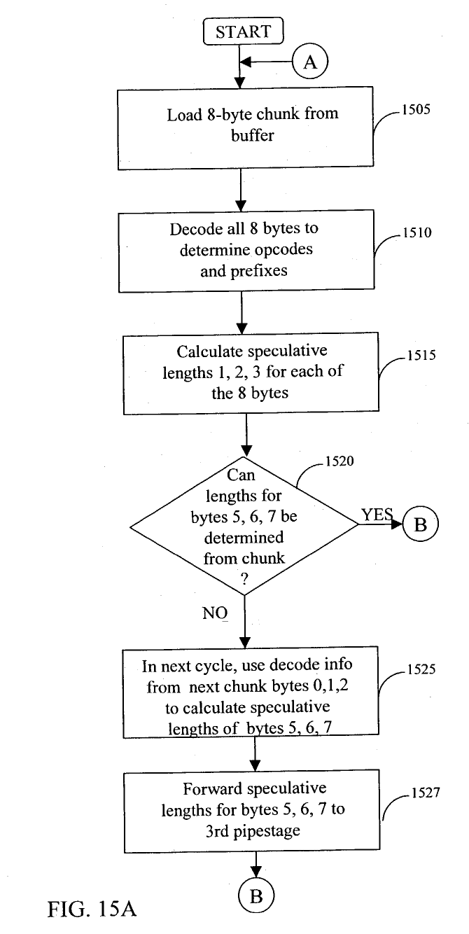

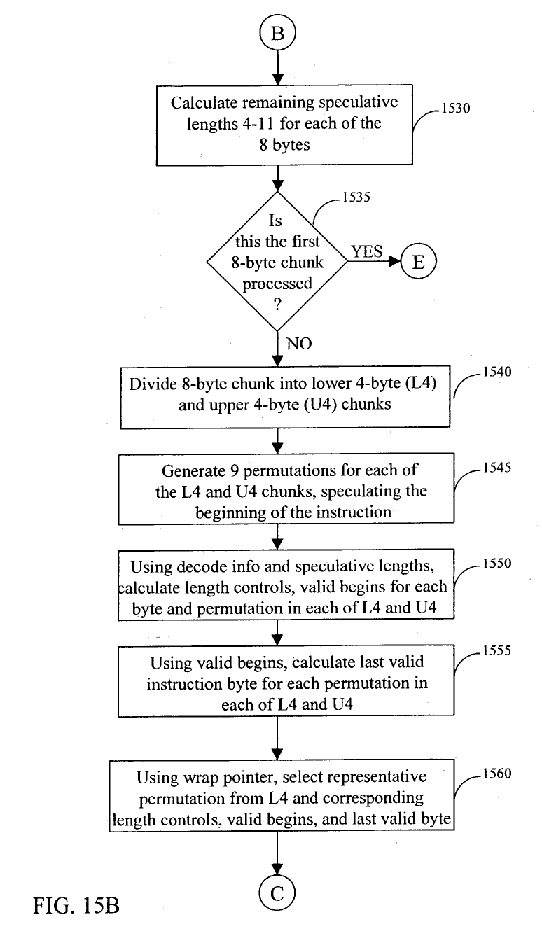

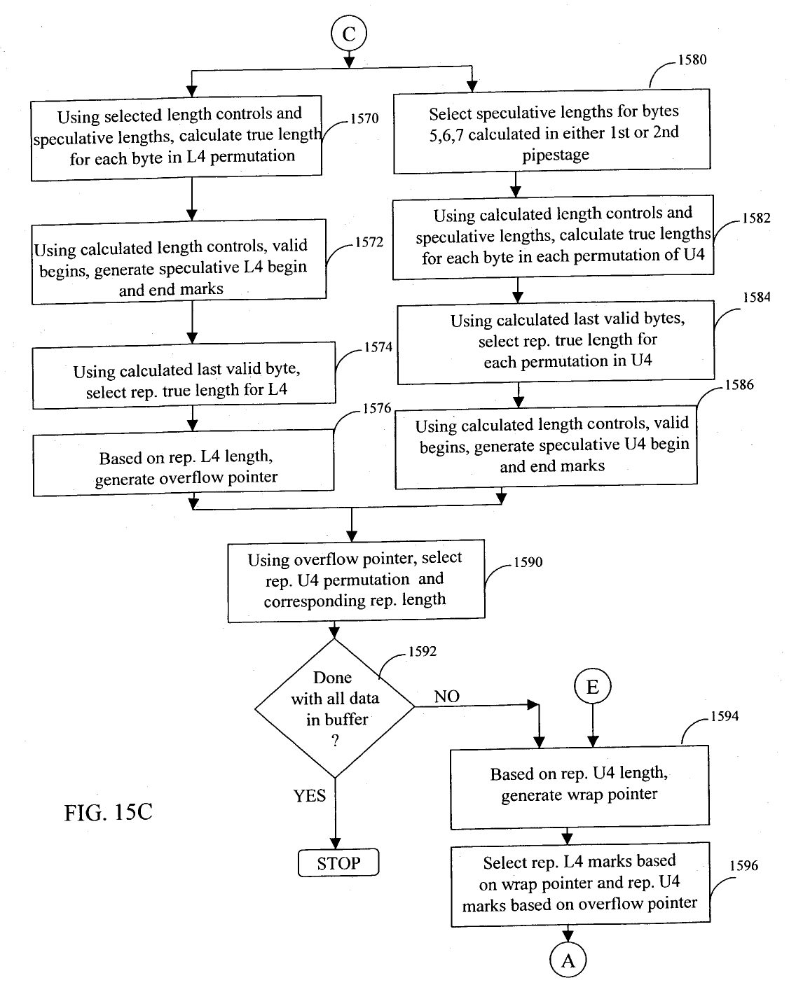

FIGS. 15A through 15C show an embodiment of the parallel pipestages and how a data chunk may be decoded in each of the three pipestages in the method of an embodiment of the present invention. FIG. 15A is a flowchart of the first pipestage. FIG. 15B is a flowchart of the second pipestage. And, FIG. 15C is a flowchart of the third pipestage. byte chunks of the datastream proceed from the first to the second to the third pipestages, resulting in the identification of the instruction bytes contained within that chunk of the datastream. Sequential 8-byte chunks may be processed concurrently in each of the three pipestages as shown in FIG. 2.

It may be understood that the size of the chunks is not limited to 8 bytes, but may vary depending on the application.

First, in FIG. 15A, the first pipestage, the variable length parallel decoder retrieves the first 8-byte chunk of the datastream from instruction buffer 305 (box 1505). Then, the variable length decoder decodes all 8 bytes of the chunk in instruction decoder 310 to determine whether each byte is a prefix, a first opcode byte, a second opcode byte, or a ModR/M byte (box 1510). The variable length decoder checks for the prefixes that affect the instruction length, i.e. the operand and address size override prefixes, 66H, 67H, and 6667H. Next, the speculative length calculator 320 calculates the speculative 1-, 2-, and 3-byte length signals of NP, P66, P67, and PB for each byte (box 1515). That is, calculator 320 assumes that each byte is the beginning of the instruction and speculates on the length of the instruction. So, calculator 320 asserts a bit if a speculative length may be possible for that byte for each of the 1-, 2-, and 3-lengths.

In some instances, bytes 5, 6, and 7 of the 8-byte chunk do not provide enough data to determine speculative lengths assuming they are the beginning byte. So, the parallel decoder makes an inquiry as to whether there is enough data in the 8-byte chunk to speculatively determine the 1-, 2-, and 3-byte lengths of instructions beginning with bytes 5, 6, and 7 (decision point 1520). If so, the decoder proceeds to the second pipestage. If not, the opcode/prefix decoding information for bytes 5, 6, and 7 is stored until the next clock cycle. Then, using the decoding information from bytes 0, 1, and 2 of the next 8-byte chunk, the 3 lengths for bytes 5, 6, and 7 are speculatively calculated (box 1525). These lengths are then forwarded to the third pipestage (box 1527). The decoder then proceeds to the second pipestage.

FIG. 15B shows the second pipestage. Speculative length calculator 320 speculatively calculates the remaining length signals bits 4-11 for each of the 8-bytes (box 1530). The result includes four 11-bit outputs, one for each of NP, P66, P67, and PB lengths, where each bit corresponds to a speculative length. A bit is asserted if the corresponding length is a possible one for that byte. The decoder then inquires if this 8-byte chunk is the first one in the datastream (decision point 1535). If so, the decoder proceeds to the third pipestage, where wrap pointer unit 350 generates wrap pointer 352.

If, however, this is not the first 8-byte chunk of the datastream, then instruction marker 330 divides the 8-byte chunk into the two 4-byte chunks, the lower chunk (L4) and an upper chunk (U4) (box 1540). After creating the 4-byte chunks, marker units 340, 360 generate 9 permutations of each 4-byte chunk (box 1545). Then, using the speculative lengths and the decode signals, control generators 335 calculates the length controls and valid begin signals for the valid byte elements of L4 and U4 permutations (box 1550). Using the valid begin signals, each of the L4 and U4 valid byte elements calculates the last valid instruction byte for each L4 and U4 permutation (box 1555). Using wrap pointer 352, L4 marker unit 340 selects the representative L4 permutation and corresponding length controls, valid begin signal, and last valid byte position (box 1560).

FIG. 15C shows the third pipestage. The third pipestage completes the decoding of the current 8-byte chunk. First, for L4, based on the length controls selected and the speculative lengths calculated in the second pipestage, L4 marker unit 340 computes the “true” length for each byte in the selected permutation (box 1570). Marker unit 340 also generates the speculative begin and end marks for each byte in each L4 permutation (box 1572). Using the calculated last valid byte, marker unit 540 selects the true length corresponding to that byte as the representative length of the instruction in L4 (box 1574). Based on the representative length, overflow pointer unit 370 generates overflow pointer 372 (box 1576).

Concurrently with the processing of the L4 chunk, the U4 chunk is processed. For U4, the speculative lengths for bytes 5, 6, and 7 are selected from those calculated in either the first pipestage from box 1527 or the second pipestage from box 1545 (box 1580). Using the calculated length controls and speculative lengths, the “true” lengths for each byte in each U4 permutation are calculated (box 1582). Using the calculated last valid bytes, U4 marker unit 360 selects the true lengths corresponding to that byte in each U4 permutation (box 1584). Marker unit 360 also generates the speculative begin and end marks for each byte in each U4 permutation (box 1586). Using generated overflow pointer 372, marker unit 360 calculates the representative U4 permutation and its corresponding instruction length (box 1590).

Next, an inquiry is made as to whether all the datastream has been processed (decision point 1592). If so, the decoding process ends and the processor proceeds to the next process. If, however, there are more 8-byte chunks to be processed, wrap pointer unit 350 generates wrap pointer 352 to determine the L4 permutation that appropriately represents the position of an instruction in the next 8-byte chunk (box 1594). Marker units 340, 360 select the representative begin and end marks for L4 based on the wrap pointer and the representative begin and end marks for U4 based on overflow pointer 372 (box 1596). Then the decoding process repeats (box 1505).

By using wrap pointer 352 in the second and third pipestages, the amount of circuitry used to perform the logic for L4 chunk processing may be reduced to that for a single permutation rather than for all 9. As a result, the area of the processor hardware may be reduced, thereby reducing the power consumption for powering the processor, and the processing speed may be increased.

It may be understood that where there are multiple 8-byte chunks, as soon as the i-th chunk has completed the first pipestage processing (FIG. 15A) and passes to the second pipestage, the i+1^{st} chunk begins first pipestage processing and the i-th chunk begins second pipestage processing (FIG. 15B). Similarly, during the next clock cycle, the i+2^{nd} chunk begins first pipestage processing, the i+1^{st} chunk begins second pipestage processing, and the i-th chunk begins third pipestage processing (FIG. 15C). It may be further understood that the i+1^{st} and i+2^{nd} chunks go through the same decoding process (beginning with box 1505) as the i-th chunk, each chunk one clock cycle after the preceding chunk.

The mechanisms and methods of embodiments of the present invention may be implemented using a general-purpose microprocessor programmed according to the teachings of the embodiments. The embodiments of the present invention thus also includes a machine readable medium, which may include instructions, which may be used to program a processor to perform a method according to the embodiments of the present invention. This medium may include, but is not limited to, any type of disk including floppy disk, optical disk, and CD-ROMs.

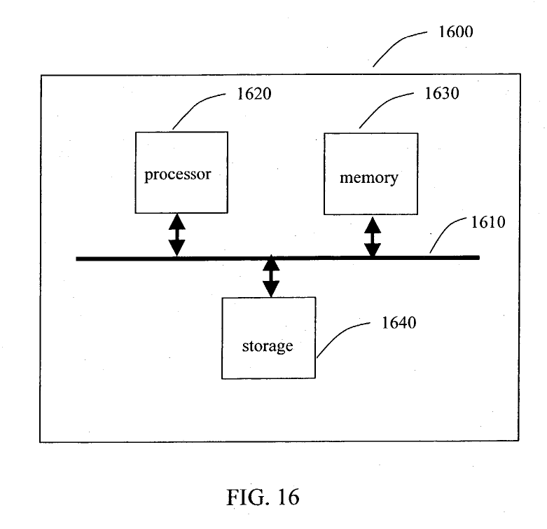

FIG. 16 is a block diagram of one embodiment of a computer system that can implement embodiments of the present invention. The system 1600 may include, but is not limited to, a bus 1610 in communication with a processor 1620, a system memory module 1630, and a storage device 1640 according to embodiments of the present invention.

It may be understood that the structure of the software used to implement the embodiments of the invention may take any desired form, such as a single or multiple programs. It may be further understood that the method of an embodiment of the present invention may be implemented by software, hardware, or a combination thereof.

The above is a detailed discussion of the preferred embodiments of the invention. The full scope of the invention to which applicants are entitled is defined by the claims hereinafter. It is intended that the scope of the claims may cover other embodiments than those described above and their equivalents.

What is claimed is:

1. A method to decode a variable length instruction in a datastream, comprising:
selecting with a first pointer one of a plurality of permutations, each permutation representing a possible location of the instruction in a portion of the datastream;
calculating a possible length of the instruction for each byte in said selected one of the plurality of permutations; and
selecting the length of the instruction from one of the calculated possible lengths in the selected permutation.

2. The method of claim 1, further comprising:
generating a second pointer based on the selected length;
calculating possible lengths of the next instruction for each byte in each of a next plurality of permutations;
selecting one of the possible lengths of the next instruction from each of the next permutations;
selecting with the second pointer one of the next permutations, the selected next permutation corresponding to the location of the next instruction in the datastream;
selecting the length of the next instruction as the selected one of the possible lengths of the next instruction in the selected next permutation; and
updating the first pointer based on the selected length of the next instruction.

3. The method of claim 1, further comprising:
decoding the portion to determine whether the instruction has a prefix; and
calculating the possible length of the instruction for each byte in the selected permutation based on the prefix determination.

4. The method of claim 1, further comprising:
marking the beginning and the ending of the instruction.

5. The method of claim 1, wherein the selecting with the first pointer comprises:
determining an ending of a previous instruction;
determining the location of a first byte of the instruction after the ending of the previous instruction;
generating the first pointer to the location of the first byte; and
selecting with the first pointer the one of the plurality of permutations in which the possible location of the instruction corresponds to the determined location of the first byte.

6. The method of claim 1, wherein the calculating comprises:
generating a length control signal for each byte in each permutation, the length control signal indicating whether the corresponding byte has a first prefix, a second prefix, a combined first and second prefix, or no prefix;
choosing the length control signal for each byte in the selected permutation; and
calculating the possible length of the instruction for each byte in the selected permutation based on the chosen length control signals.

7. The method of claim 1, wherein the selecting the length of the instruction comprises:
determining which byte in the selected permutation is the first byte of the instruction; and
determining the possible length of the instruction corresponding to the determined byte.

8. The method of claim 1, wherein:
a first of the permutations represents the start of the instruction in a first byte of the portion,
a second of the permutations represents the start of the instruction in a second byte of the portion,
a third of the permutations represents the start of the instruction in a third byte of the portion,
a fourth of the permutations represents the start of the instruction in a fourth byte of the portion,
a fifth of the permutations represents the end of the instruction in the fourth byte of the portion,
a sixth of the permutations represents a middle of the instruction in all bytes of the portion,
a seventh of the permutations represents the instruction having an operand size override prefix,
an eighth of the permutations represents the instruction having an address size override prefix, and
a ninth of the permutations represents the instruction having a combined operand and address size override prefix.

9. A method to decode a variable length instruction, comprising:
dividing a datastream that includes the instruction into a plurality of portions;
parallel decoding of each of the portions in a plurality of pipestages,
in a first of the pipestages for an i-th portion,
determining whether the instruction has a prefix, and
determining speculative lengths of the instruction based on the prefix determination,
in a second of the pipestages for the i-th portion,
generating a plurality of permutations to represent a plurality of possible locations of the instruction in the portion, and
selecting with a first pointer the permutation that represents a location of the instruction in the portion, and in a third of the pipestages for the i-th portion,
calculating an actual length of the instruction based on the speculative lengths for the selected permutation,
if the portion includes the start of the instruction, identifying the start of the instruction,
if the portion includes the end of the instruction, identifying the end of the instruction, and
generating a second pointer to a permutation of an (i+1)-th portion that represents a location of the instruction in the (i+1)-th portion; and
executing the instruction.

10. The method of claim 9, wherein the selecting comprises:
identifying an end of the previous instruction;
identifying the start of the instruction after the end of the previous instruction; and
generating the first pointer to the permutation that indicates the start of the instruction.

11. The method of claim 97 wherein the selecting comprises:
determining that the portion represents a middle of the instruction; and
generating the first pointer to the permutation that indicates the middle of the instruction.

12. An apparatus to decode a variable length instruction, comprising:
a permutation selector to select with a first pointer one of a plurality of permutations, each permutation representing a possible location of the instruction in a portion of the datastream;
a length calculator to calculate a possible length of the instruction for each byte in said selected one of the plurality of permutations; and
a length selector to select the length of the instruction from one of the calculated possible lengths in the selected permutation.

13. The apparatus of claim 12, wherein the permutation selector is to:
receive the location of a first byte of the instruction;
select with the first pointer the one of the plurality of permutations in which the possible location of the instruction corresponds to the location of the first byte; and
choose a length control signal for each byte in the selected permutation, the length control signal indicating whether the corresponding byte in the selected permutation has a first prefix, a second prefix, a combined first and second prefix, or no prefix.

14. The apparatus of claim 12, wherein the length calculator is to:
calculate the possible length of the instruction for each byte in the selected permutation based on a chosen length control signal, the length control signal indicating whether the corresponding byte in the selected permutation has a first prefix, a second prefix, a combined first and second prefix, or no prefix.

15. The apparatus of claim 12, wherein the length selector is to:
determine which byte in the selected permutation is the first byte of the instruction; and
determine the possible length of the instruction corresponding to the determined byte.

16. The apparatus of claim 12, further comprising:
a byte decoder to decode the portion to determine whether the instruction has a prefix.

17. An apparatus to decode a variable length instruction, comprising:
an instruction buffer to store a datastream that includes the instruction as a plurality of portions;
an instruction decoder;
a speculative length calculator; and
an instruction marker,
wherein, in a first of a plurality of parallel pipestages for an i-th portion,
the decoder determines whether the instruction has a prefix, and
the calculator determines speculative lengths of the instruction based on the prefix determination,
wherein, in a second of the plurality of parallel pipestages for the i-th portion, the marker
generates a plurality of permutations to represent a plurality of possible locations of the instruction in the portion, and
selects with a first pointer the permutation that represents the location of the instruction in the portion, and
wherein, in a third of the plurality of parallel pipestages for the i-th portion, the marker
calculates an actual length of the instruction based on the speculative lengths for the selected permutation,
if the portion includes the start of the instruction, identifies the start of the instruction,
if the portion includes the end of the instruction, identifies the end of the instruction, and
generates a second pointer to a permutation of an (i+1)-th portion that represents the location of the instruction in the (i+1)-th portion.

18. The apparatus of claim 17, wherein the marker selecting the permutation includes:
identifying an end of the previous instruction;
identifying the start of the instruction after the end of the previous instruction; and
generating the first pointer to the permutation that indicates the start of the instruction.

19. The apparatus of claim 17, wherein the marker selecting the permutation includes:
determining that the portion represents a middle of the instruction; and
generating the first pointer to the permutation that indicates the middle of the instruction.

20. A machine readable medium including program instructions to be executed by a processor to implement a method to decode a variable length instruction, the method comprising:
selecting with a first pointer one of a plurality of permutations, each permutation representing a possible location of the instruction in a portion of the datastream;
calculating a possible length of the instruction for each byte in said selected one of the plurality of permutations; and
selecting the length of the instruction from one of the calculated possible lengths in the selected permutation.

21. The machine readable medium of claim 20, wherein the method further comprises:
generating a second pointer based on the selected length;
calculating possible lengths of the next instruction for each byte in each of a next plurality of permutations;
selecting one of the possible lengths of the next instruction from each of the next permutations;
selecting with the second pointer one of the next permutations, the selected next permutation corresponding to the location of the next instruction in the datastream;
selecting the length of the next instruction as the selected one of the possible lengths of the next instruction in the selected next permutation; and
updating the first pointer based on the selected length of the next instruction.

22. The machine readable medium of claim 20, wherein the method further comprises:
decoding the portion to determine whether the instruction has a prefix; and
calculating the possible length of the instruction in each byte of the selected permutation based on the prefix determination.
